(19) United States
(12) Patent Application Publication
(10) Pub. No.: US 2003/0217198 A1
(43) Pub. Date: Nov. 20, 2003

(54) Image signal output apparatus and image signal control method

(75) Inventor: Yutaka Arai, Atsugi-shi (JP)

Correspondence Address: SCULLY SCOTT MURPHY & PRESSER, PC, 400 GARDEN CITY PLAZA, GARDEN CITY, NY, 11530

(73) Assignee: NEC-MITSUBISHI ELECTRICAL VISUAL SYSTEMS CORPORATION, Tokyo (JP)

(21) Appl. No.: 10/428,884

(22) Filed: May 2, 2003

(30) Foreign Application Priority Data
May 15, 2002 (JP) 2002-140704

(51) Int. Cl. G06F 3/00

(52) U.S. Cl. 710/1

(57) ABSTRACT

An object is to be able to display an image even if connected to an unspecified image display apparatus, and to be able to display an image on a latter image display apparatus even if a former image display apparatus is faulty. An index composite signal output from an image signal generator 11 is sent to an image signal output apparatus 12, and a net image signal, a synchronization signal and a transmission index signal are separated. Then, in the case where an image output apparatus number set in the image signal output apparatus 12 and the transmission index signal are matched, the net image signal contained in the frame having the image output apparatus number from the image signal side is output to an image signal display apparatus 13. Moreover an index composite signal output from the image signal generator 11 is also sent to a special image signal display apparatus 14. As a result, the net image signal is displayed on the appropriate image signal display apparatus 13, independent of the condition of the former apparatus.

### BACKGROUND OF THE INVENTION

1. Field of the Invention

The present invention relates to an image signal output apparatus which receives an image signal having a predetermined format used for example in a personal computer (hereunder referred to as a PC), and outputs a signal selected based on an index signal contained in this image signal. Moreover, the invention relates to an image signal distributor having a plurality of devices which output a signal selected based on an index signal contained in an image signal, and a control method for an image signal.

2. Description of the Related Art

In Japanese Unexamined Patent Application, First Publication No. 2000-352962, there is disclosed a system for an image signal generator in which an image signal generating device and connection cables are not increased even with an increase in the number of image signal generators. This technology is furnished with an image signal generator which generates a composite image signal which contains an index signal, and an image display device which receives an output signal from the image signal generator and displays an image signal. By means of such a construction, an image signal of an arbitrary number of pixels (or pages) can be displayed on an arbitrary number of image display apparatuses using a single image signal route or a single image signal generating device.

However, in the technology of the aforementioned Japanese Unexamined Patent Application, First Publication No. 2000-352962, since each of the image signal display apparatuses have an image frame selection device containing an index signal discriminating device, then in the case where an existing image signal display apparatus which is not furnished with such a configuration is connected, then normally an image cannot be displayed. Therefore, on an existing system, in order to display a pixel image signal of an arbitrary number of pixels (or pages) on an arbitrary number of image display apparatuses, processing to either dispose of the existing image display apparatus or redeploy this somewhere else becomes necessary.

The present invention addresses the above mentioned situation, with an object being to provide an image signal output apparatus which can display an image even if connected to an image display apparatus of any configuration, and to provide an image signal distributor which enables a plurality of existing image display apparatuses to be connected, by having a plurality of devices for outputting signals.

### SUMMARY OF THE INVENTION

In order to achieve the above mentioned objects, an image signal output apparatus of the present invention comprises: an image signal receiving device which receives a composite signal containing, an image signal comprising a plurality of image frames, a synchronization signal corresponding to the image signal, and a transmission index signal substituted for one part of the image signal in an arbitrary image frame of the image signal, and outputs the image signal and the synchronization signal; an index discriminating device which discriminates a transmission index signal contained in either of an image display period and an image non display period in an image frame, based on the image signal and the synchronization signal output from the image signal receiving section; an image output apparatus number setting device for outputting an image output apparatus number set for its own apparatus; a frame selection device which, based on an index signal output by the index discriminating device, and an image output apparatus number of its own apparatus output by the image output apparatus number setting device, outputs a frame selection signal for selecting an image frame contained in an image signal; an image storage device which stores an image signal corresponding to an image frame in accordance with a frame selection signal output from the frame selection device; and an image signal output device which outputs an image signal corresponding to an image frame.

Furthermore, in the image signal output apparatus of the present invention, an image frame selection section comprises; the index discriminating device, the image output apparatus number setting device, the frame selection device, and the image storage device.

Furthermore, in the image signal output apparatus of the present invention further comprises an index holding device which holds an index signal and a communication device connected to the image output apparatus number setting device.

Moreover, in the image signal output apparatus of the present invention, the image signal output device comprises a signal converting device which converts a signal to a necessary format for display on an existing display apparatus, and a D/A converter which converts a digital signal into an analog signal.

Furthermore, an image signal distributor of the present invention comprises an image frame selection section and an image signal output section which outputs an image signal corresponding to an image frame, and the image frame selection section comprises: an index discriminating device which, based on an image signal and a synchronization signal output from an image signal receiving device, discriminates a transmission index signal which is contained in either of an image display period or an image non display period in an image frame; an image output apparatus number setting device for outputting an image output apparatus number which is set for its own apparatus; a frame selection device which, based on an index signal output by the index discriminating device and an image output apparatus number of its own apparatus output by the image output apparatus number setting device, outputs a frame selection signal for selecting the image frame contained in an image signal; and an image storage device which stores an image signal corresponding to an image frame in accordance with a frame selection signal output from the frame selection device, and the image frame selection section and the image signal output section are made up of several sections.

Furthermore, in a control method for an image signal according to the present invention, a control method for an image signal which performs control of an image signal from receiving an index composite signal up until outputting a display signal is characterized in comprising; a first step for receiving an index composite signal containing a transmission index signal which is substituted for one part of an image signal in an arbitrary image frame of an image signal comprising a plurality of image frames; and a second step for selecting an image frame to be output by its own apparatus, from a plurality of image frames based on a transmission index signal contained in the received index composite signal, and outputting an image signal corresponding to the selected image frame.

Moreover, the control method for an image signal according to the present invention is characterized in that the second step further comprises; a procedure for discriminating a transmission index signal from an index composite signal and outputting an index signal; a procedure for outputting a frame selection signal based on an output index signal and an image output apparatus number set for its own apparatus; a procedure for selecting an image frame contained in an image signal in accordance with the output frame selection signal; a procedure for storing an image signal corresponding to the selected image frame; and a procedure for outputting the stored image frame.

It is possible to select and output an arbitrary frame from the image signal and also to display the arbitrary frame on the image display apparatus which is connected in accordance with the image output apparatus number. Moreover, since the image signal which is stored in the image storing device is not updated, the contents immediately before are continuously displayed. Moreover, it is also possible to deliver the signal to a plurality of image signal display apparatuses by one image signal distributor.

### BRIEF DESCRIPTION OF THE DRAWINGS

FIG. 1 is a block diagram showing a concept for an image display system according to a first through fifth embodiment of the invention.

FIG. 2 is a block diagram showing a configuration of an image signal output apparatus in a first embodiment of the invention.

FIG. 3 is a block diagram showing a configuration of an image signal receiving device in the first embodiment of the invention.

FIG. 4 is a time chart showing image signals and an index in the case where a horizontal synchronization signal is input, in the first embodiment of the invention.

FIG. 5 is a time chart showing image signals and indexes in the case where a vertical synchronization signal is input, in the first embodiment of the invention.

FIG. 6 shows an index in the first embodiment of the invention.

FIG. 7 shows flags in the first embodiment of the invention.

FIG. 8 is a time chart showing image signals and an index in the first embodiment of the invention.

FIG. 9 shows an index in the first embodiment of the invention.

FIG. 10 shows an index in the first embodiment of the invention.

FIG. 11 shows an index in the first embodiment of the invention.

FIG. 12 is a block diagram showing a configuration of an image receiving device in a second embodiment of the invention.

FIG. 13 shows an index and flags in the second embodiment of the invention.

FIG. 14 shows an index and flags in the second embodiment of the invention.

FIG. 15 is a block diagram showing a configuration of an image signal output apparatus in the second embodiment of the invention.

FIG. 16 is a block diagram showing a configuration of an image signal output apparatus in a third embodiment of the invention.

FIG. 17 shows image signals and indexes in the third embodiment of the invention.

FIG. 18 is a block diagram showing a configuration of an image signal output apparatus in a fourth embodiment of the invention.

FIG. 19 is a block diagram showing a configuration of an image signal output apparatus in a fifth embodiment of the invention.

FIG. 20 shows image signals and an index in the fifth embodiment of the invention.

FIG. 21 is a block diagram showing a concept of an image system in a sixth embodiment of the invention.

FIG. 22 is a block diagram showing a configuration of an image signal distributor in the sixth embodiment of the invention.

### DETAILED DESCRIPTION OF THE INVENTION

First Embodiment

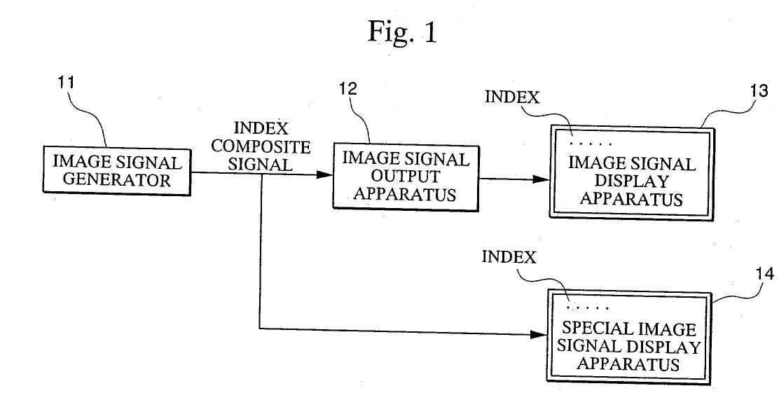

At first, is a description of a general outline of a first embodiment. FIG. 1 is a block diagram conceptually showing an image display system in the first embodiment of the invention. In FIG. 1, this image display system comprises; an image signal generator 11, an image signal output apparatus 12, an image signal display apparatus 13, and a special image signal display apparatus 14. As shown in FIG. 1, the image signal generator 11 and the image signal display apparatus 13 are electrically connected via the image signal output apparatus 12 by means of a cable or the like, and the special image signal display apparatus 14 is connected directly to the image signal generator 11.

In the disclosure of Japanese Unexamined Patent Application, First Publication No. 2000-352962, the environment of a multi display could be easily realized by having a plurality of connections for the special image signal display apparatus 14 shown in FIG. 1. However, in this case, a special image display apparatus having the function of discriminating indexes was necessary. Therefore, in this invention, the image signal output apparatus 12 is added to realize a multi display environment.

Hereunder is a description of the operation using the image signal output apparatus 12 of the invention. The image signal generator 11 is the same as the image signal generator disclosed in Japanese Unexamined Patent Application, First Publication No. 2000-352962, and outputs; a net image signal which is actually displayed on an image display section (for example an LCD, CRT, PDP, ELD etc.) having the image signal display apparatus 13 and the special image signal display apparatus 14, a synchronization signal corresponding to the net image signal, and a transmission index signal which is substituted for one part of the net image signal. Here the image signal, the synchronization signal and the transmission index signal are referred to generally as an index composite signal. Moreover, in the following description, provided there is no objection, then also in the case where the transmission index signal is simply added in the image non display period, this represents substituting for one part of the image signal.

The index composite signal output from the image signal generator 11 is applied to the image signal output apparatus 12. Here an index composite signal having the same contents is also applied to the special image signal display apparatus 14. In the image signal output apparatus 12, respective signals basically of the net image signal, the synchronization signal and the transmission index signal are separated from the received index composite signal. Then, in the case where the image output apparatus number set in the image signal output apparatus 12 and the transmission index signal are matched, the net image signal contained in the frame having the image output apparatus number from the image signal side is stored in the image storage device, and the image signal stored in the image storage device is output to the image signal display apparatus 13.

In the case where the transmission index signal is substituted for one part of the net image signal and output from the image signal generator 11, then within the display image in the image signal display apparatus 13, the display shown as the index as shown in FIG. 1 is displayed together with the display in the net image signal. Here, the index is not displayed in the case of an image non display period.

The above described situation is as follows in describing the control method for an image signal output apparatus from reception of an index composite signal up until output of the display signal. That is to say, in a first step, an index composite signal containing a transmission index signal which has been substituted for one part of an image signal, in an arbitrary image frame of an image signal comprising a plurality of image frames is received. Next, in a second step, an image frame to be output by its own apparatus is selected from the plurality of image frames based on the transmission index signal contained in the received index composite signal, and an image signal corresponding to the selected image frame is output. In the second step, there is included respective steps from (a) to (e) as described next in detail.

(a) the transmission index signal is discriminated from the index composite signal and the index signal output. (b) the frame selection signal is output based on the output index signal and the image output apparatus number set for its own apparatus. (c) an image frame contained in an image signal corresponding to the output frame selection signal is selected. (d) an image signal corresponding to the selected image frame is stored. (e) the stored image frame is output.

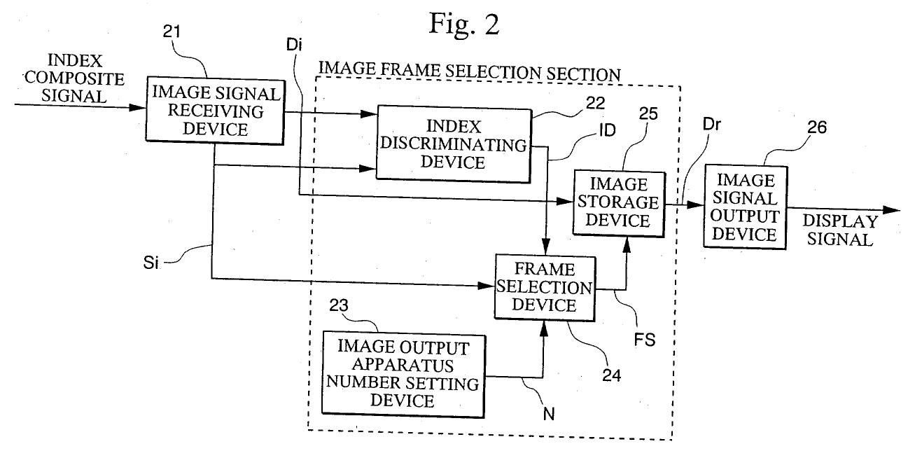

Next is detailed description of the first embodiment. FIG. 2 shows the internal configuration of the image signal output apparatus 12 shown in FIG. 1. In FIG. 2, the image signal output apparatus 12 comprises; an image signal receiving device 21, an index discriminating device 22, an image output apparatus number setting device 23, a frame selection device 24, an image storage device 25 and an image signal output device 26.

Di denotes an image signal output from the image signal receiving device 21, Dr denotes an image signal which the image storage device 25 outputs, Si denotes a synchronization signal which the image signal receiving device 21 outputs, ID denotes an index which is discriminated by the index discriminating device 22, N denotes an image output apparatus number set by the image output apparatus number setting device 23, and FS denotes a frame selection signal which the frame selection device 24 outputs.

Here in the description of the respective embodiments mentioned hereunder, while not particularly limiting, the image signal receiving device 21 constitutes the image signal receiving section, the index discriminating device 22, the image output apparatus number setting device 23, the frame selection device 24, the image storage device 25, and the devices respectively associated with these constitute the image frame selection section, and the image output device 26 constitutes the image output section.

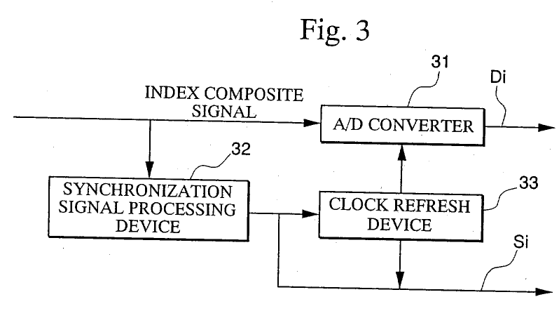

FIG. 3 is a block diagram showing a configuration of the image signal receiving device 21. In FIG. 3, the image signal receiving device 21 comprises; an A/D converter 31, a synchronization signal processing device 32, and a clock refresh device 33. In the figure, the same numbers and the same symbols indicate the same devices or the same signals.

Next is a description of the operation of the image signal receiving device 21 shown in FIG. 3. As shown in FIG. 1, the index composite signal, which contains the image signal with the transmission index signal substituted for one part of the image signal, the respective vertical and horizontal synchronization signals synchronized with this image signal, and which is generated by the image signal generator 11, is input to the image signal receiving device 21 shown in FIG. 2 of the image signal output apparatus 12, through a connection cable.

FIG. 3 shows the internal configuration of the image signal receiving device 21, as with the configuration shown in the figure, the input index composite signal is applied to the A/D converter 31 and the synchronization signal processing device 32. An image signal Di is output from the A/D converter 31 as a digital image signal. On the other hand, by inputting an index composite signal to the synchronization signal processing device 32, the synchronization signal Si corresponding to the image signal contained in this index composite signal is separated. This synchronization signal Si is output to the outside of the image signal receiving device 21, and is also output to the clock refresh device 33.

In the clock refresh device 33, a predetermined frequency clock with the input synchronization signal Si as a reference, is output as a sampling clock for when the image signal contained in the index composite signal input to the A/D converter 31 is A/D converted, and is output to outside of the image signal receiving device 21 as one part of the synchronization signal Si.

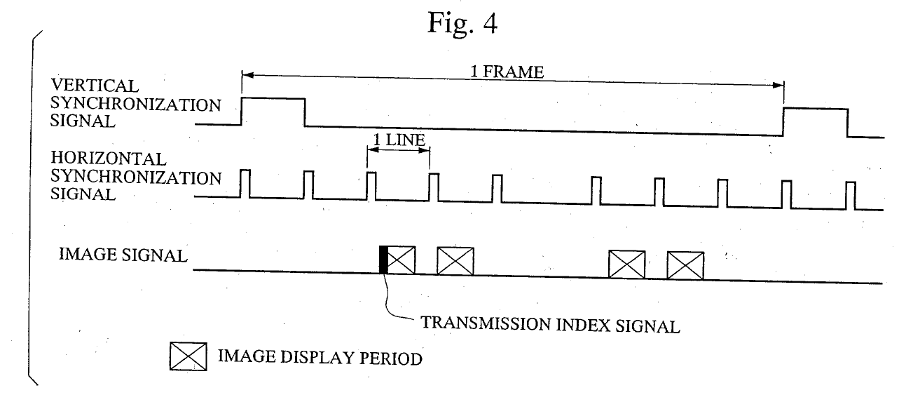

FIG. 4 is a timing chart of the index composite signal output from the image signal generator 11 shown in FIG. 1 for the case where the transmission index signal is substituted for one part of the image signal. The horizontal axis represents time and the vertical axis represents voltage. As will be understood from FIG. 4, the relationship of the respective timings of the vertical synchronization signal, the horizontal synchronization signal and the image signal in a single frame period is shown.

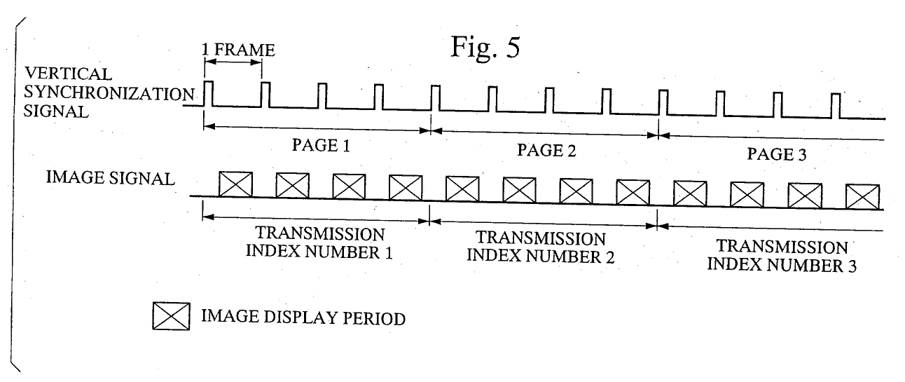

FIG. 5 is a time chart for explaining a relationship of the timing of an image signal of a plurality of pages and a transmission index signal substituted for one part of the image signal, which the image signal generator 11 shown in FIG. 1 outputs. In FIG. 5, the horizontal axis represents time and the vertical axis represents voltage. Moreover, page referred to here, as will be understood with reference to FIG. 5, is a page comprising two or more timewise consecutive frames. Furthermore, the definition of page means one section for the case where one display screen is divided into one or a plurality of regions. That is to say, one display screen is constituted by one or a plurality of regions. Alternatively, the definition of page includes one type of display screen in a plurality of types of display screens for which the contents are basically each different in different pages.

In FIG. 5, to simplify understanding, the transmission index number corresponding to page 1 corresponds to index 1, the transmission index number corresponding to page 2 corresponds to index 2, and the transmission index number corresponding to page 3 corresponds to index 3. At this time, since the transmission index signal is positioned at the start of the image period of one frame, the obtained index and page can be made to coincide. In the case where the timing for adding the transmission index signal is not at the beginning of the image period, the detected index ID is applied to the next frame.

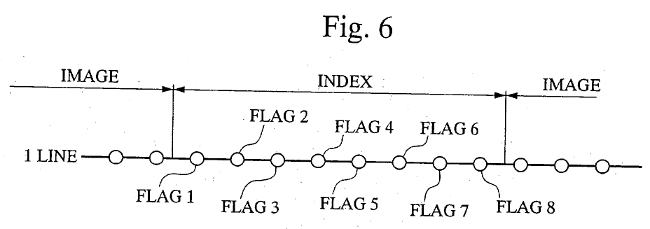

FIG. 6 is an explanatory diagram showing a specific example of a transmission index signal contained in an index composite signal output by the image signal generator 11, showing one part of one line in an image signal corresponding to one line on the display image. In FIG. 6, the circle indicates one pixel. The transmission index signal comprises for example 8 pixels at predetermined positions (here on one line on the display screen) of an image period. A desired lighting (brightness) is set for the respective pixels which constitute the transmission index signal. Based on this lighting (brightness), as described later, a flag is created corresponding to the image output apparatus number.

Hereunder is a description of the operation with reference to FIG. 6. As shown in FIG. 2, the index composite signal input to the image output apparatus 12 is received by the image signal receiving device 21. The image signal receiving device 21, as described in FIG. 3, outputs a synchronization signal Si and an image signal Di which has been digitized. In this case, the transmission index signal in the image signal Di is substituted within the image signal Di and digitized. As shown in FIG. 3, the synchronization signal Si and the image signal Di output from the synchronization signal processing device 32 contained in the image signal receiving device 21, are input as shown in FIG. 2, to the index discriminating device 22, the frame selection device 24, and the image storage device 25.

The index discriminating device 22 computes the position within the image signal, of the transmission index signal which is constituted by the light and shade of the pixel shown in FIG. 6, with the synchronization signal Si as a reference for the timing (datum reference on the time axis), and extracts the received transmission index signal. The transmission index signal, from a noise tolerance point of view, is more simply expressed by a combination of gradations of the maximum value or the minimum value of half-toning (that is, the 255th gradation or the 0th gradation in 256 half-toning). Hereunder, to simplify the description, the transmission index signal is constituted by combining the maximum values or the minimum values of the half-toning.

The received transmission index signal, is binarized in the index discriminating device 22 based on a previously set threshold value. As one example of this threshold value, the 128th gradation being the gradation of half the 256 gradations is adopted as the threshold value. In this case, for example a flag of “1” is applied when the gradations are from 255 gradations to 129 gradations, and a flag of “0” is applied when the gradations are from 0 gradations to 128 gradations, and the index ID is constructed by combining these flags.

Moreover, as a threshold value for the gradations, from the viewpoint of further increasing noise immunity, in order to impart hysteresis properties, a “1” can be given to the flag when the gradations are from 255 gradations to 192 gradations (value of ¾ of the 256 gradations), and a “0” can be given to the flag when the gradations are from 0 gradations to 64 gradations (value of ¼ of the 256 gradations), and the index ID can be constructed by combining these flags.

The index discriminating device 22 outputs the index ID obtained in the above mentioned manner to the frame selection device 24. On the other hand, the image output apparatus number setting device 23 outputs an image output apparatus number N previously set for its own apparatus to the frame selection device 24. In this image output apparatus number N, for example a plurality of combinations of “1” or “0” are set by hardware settable dip switches. Moreover, in the image output apparatus number setting device 23, a display apparatus may be added to show the image display apparatus number for easier understanding. The frame selection device 14 outputs a frame selection signal FS based on the selected index ID and the image output apparatus number N.

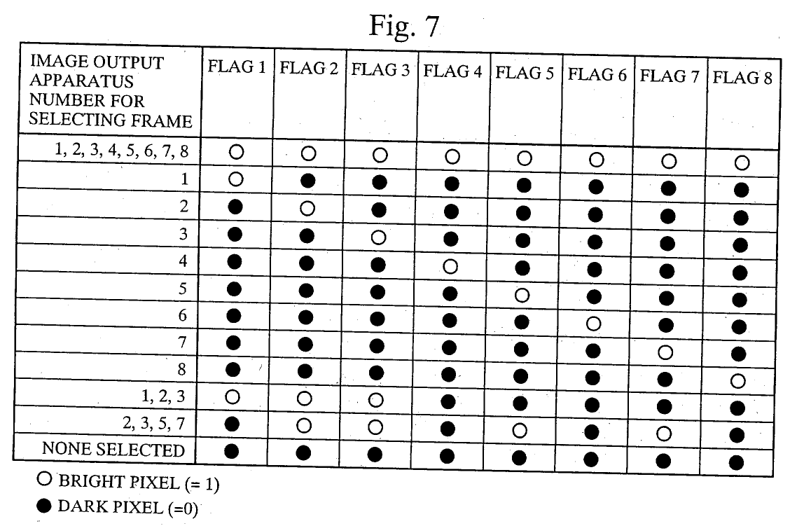

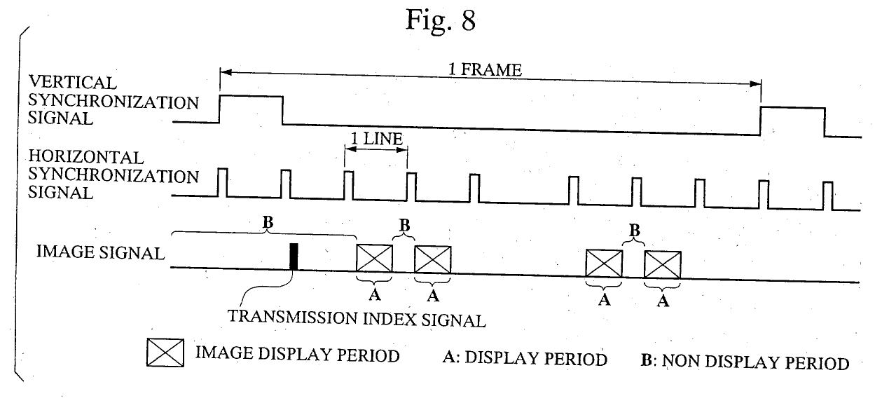

FIG. 7 shows the relationship of the index ID and the image output apparatus number N for selecting the frame. Moreover, FIG. 8 is a time chart showing the relation between image signals and an index. In FIG. 7, the white circles show the flags corresponding to bright pixels, and the black circles show the flags corresponding to dark pixels. As described above, an 8 bit flag is generated by binarizing the transmission index signal in the index discriminating device 22. That is, corresponding to the transmission index signal shown in FIG. 8. Here since the index ID comprises an 8 bit flag, then at maximum the case of 256 (display modes) can be specified. In this case, the number of numbers for the controllable image output apparatus coincides with the number of bits of the index ID.

As will be understood with reference to FIG. 7, in the case where all of the flags are “1”, then in all of the image output apparatuses 12, a frame having a transmission index signal such that all of the flags become “1” is selected. That is, in all cases no matter how the image output apparatus number is set, an image signal for this frame is output. Moreover, in the case where the flag 1 is “1”, then in the case where a “1” is set for the image output apparatus number N, a frame such that the flag 1 generated from the transmission index signal becomes “1” is selected, while in the case where the flag 2 is “1”, a frame such that the flag 2 generated from the transmission index signal in the case where a “2” is set for the image output apparatus number N becomes “1”, is selected.

The frame selection device 24 compares the index ID which the index discriminating device 22 outputs, with the image output apparatus number which the image output apparatus number setting device 23 outputs, and outputs a frame selection signal FS for selecting a frame so that these match as mentioned above. Here, the transmission index signal is substituted for one part of the image signal, and a judgment is made for the frame to be actually selected which becomes the frame.

In the image storage device 25, a predetermined frame is selected from the input image signal Di and stored, based on the frame selection signal FS which the frame selection device 24 has output. The image signal stored in the image storage device 25 is read out at a predetermined timing, and output to the image output device 26 as an image signal Dr. The image output device 26 outputs an image signal Dr which has been read out from the image storage device 25, as a format which can be displayed by a connected display apparatus.

In the case where a frame is not selected by the frame selection device 24, then so that the contents stored in the image storage device 25 are not updated, for example the last selected image signal Dr is output. By configuring in the above manner, the image output apparatus 12 can select an arbitrary frame from the received image signal and output this. Consequently, as shown in FIG. 1, an arbitrary page can be displayed on the connected image display apparatus 13 corresponding to the image output apparatus number.

In the description of the operation up until here, the case has been described where the transmission index signal is substituted for one part of the image signal at a position within an image period. However the transmission index signal may be substituted for one part of the image signal within a non image period (that is a period which is not an image period, for example a blanking period).

FIG. 8 is a timing chart for explaining about the case where the transmission index signal is substituted for one part of the image signal in the non display period of the image signal. In FIG. 8, the horizontal axis represents time and the vertical axis represents voltage. Here, the index discriminating device 22 shown in FIG. 2 is configured so as to discriminate the transmission index signal substituted for one part of the image signal in the non image period, with the synchronization signal Si as a reference. That is to say, the index discriminating device 22 computes the position within the non image period, of the transmission index signal which is constituted by the light and shade of the pixel shown in FIG. 6, with the synchronization signal Si as a reference for the timing (that is, a datum reference on the time axis), and extracts the received transmission index signal. In the first embodiment, since the substitution of the transmission index signal within the image period is not performed, there is no display of the index on the display screen of the image display apparatus 13, and hence this does not become an obstruction on the screen.

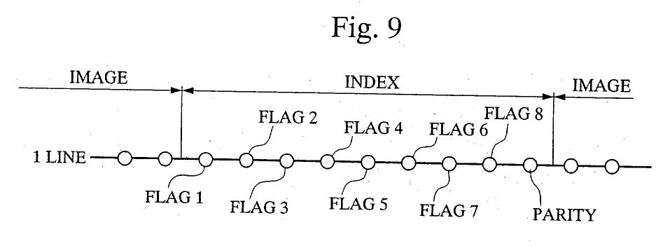

FIG. 9 is an explanatory diagram showing an example where, in the image signal generator 11, parity is included in the transmission index signal in order to avoid a malfunction due mainly to noise or the like on the index signal. As with the case of FIG. 9, the index discriminating device 22 of FIG. 2 also binarizes the parity signal together with the transmission index signal, and makes a comparison of the detected transmission index signal and the parity signal based on a previously established definition. As the parity definition here, in one example, with an exclusive logical numerical operator signal between two flags as E, flags 1 to 8 as F1 to F8, and the obtained result as P, then P obtained from the calculation of P=(((((((F1, E, F2) E, F3) E, F4) E, F5) E, F6) E, F7) E, F8) is the parity.

In the case where the image signal receiving device 21 judges from the result of this comparison, that the transmission index signal cannot be normally received, then the frame containing this transmission index signal is one where all of the image output apparatuses 12 are not selected, so that it is possible to prevent the frame selection signal FS being output from the frame selection device 24. In this case, since updating of the image signal stored in the image storage device 25 is not performed, the contents directly before continue to be displayed. Moreover, in the case where the transmission index signal is not displayed, for example in the case where a transmission index number is not contained in the image signal, then the frame which contains this transmission index signal is one which is selected by all of the image output apparatuses 12, and the frame selection signal can also be output from the frame selection device 24. In this case, the output image is updated for all of the image output apparatus number settings.

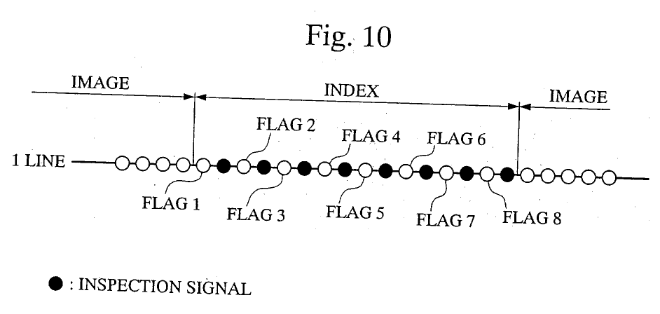

FIG. 10 is an explanatory diagram showing another configuration which includes a parity in the transmission index signal. In FIG. 10, the example is shown where inspection pixels for each one pixel are arranged between an 8 pixel flag. The inspection pixels in this figure are ones where the light and shade of the flag for example on the left edge are reversed. In this manner, by receiving and discriminating the signals where the inspection pixels are arranged with respect to each flag, then for example a damaged condition of the transmission index signal due to a mouse pointer or the like being passed over the transmission index signal, or a condition where the transmission index signal is not substituted for one part of the image signal, or a condition where there is no display, can be detected.

Furthermore, the index discriminating device 22, in the case where the transmission index signal is not substituted for one part of the image signal, or in the case where there is no display, can also output an index ID such that the frame selection device 24 selects all of the frames. As a result, the output signal can be updated in all frames without setting the image output apparatus number, and an output obtained in accordance with the change of frame. Moreover, by arranging the inspection pixels for each of the flags, a signal portion which is damaged within the transmission index signal can be specified. In this case, the index discriminating device 22 makes the portion which is damaged inside the obtained flag for example “0”, and for the flag which is not damaged this is used as is as a valid flag.

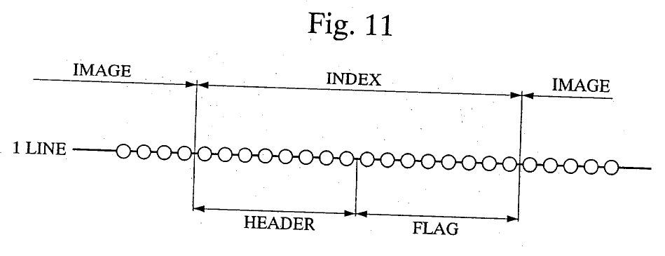

FIG. 11 shows another configuration of a transmission index signal. In FIG. 11 is shown an example where a header showing that there is an index signal, and which is constituted by light and shade of a plurality of pixels before the transmission index signal of eight pixel parts is added. In this case, in the index discriminating device 22, the header portion is also binarized as well as the transmission index signal, and by making a comparison with the configuration of a previously determined header, it can be judged that the index signal is being received.

In the above mentioned judgment, in the case where it is judged that the header is not normal, a condition where the transmission index signal has not been substituted for one part of the image signal, or a condition where this is not displayed can be detected. Furthermore, the index discriminating device 22, in the case where the transmission index signal is not substituted for one part of the image signal, or in the case where there is no display, can also output an index ID such that the frame selection device 24 selects all of the frames. In this case, a display in accordance with the contents of the frame results.

Moreover, by determining the pattern of the header beforehand, it becomes easy for the index discriminating device 22 to detect the header, and even if the transmission index signal is arranged at an arbitrary position of the image signal (that is a position on the time line), the position of the transmission index signal within the image signal can be easily found, and also it is possible to reliably extract the transmission index signal. Furthermore, in the above mentioned description of the operation, the example was also given for the case where the transmission index signal was constituted by eight pixels. However it is not limited to this, and may be constituted by an arbitrary number of pixels. Here, the number of numbers for the controllable image output apparatus basically coincides with the number of flags in the transmission index signal.

Moreover, in the above mentioned description of the operation, the example was given for where the transmission index signal was constituted by a plurality of pixels continuous horizontally. However this may also be constituted by a plurality of pixels continuous vertically. In this case, the index discriminating device 22 also performs detection of the vertically aligned pixels. Furthermore, in the above mentioned description of the operation, the example was given for where the transmission index signal was constituted by a plurality of pixels continuous horizontally. However this may be constituted by pixels of a two dimensional array arranged horizontally and vertically. Moreover, in the above mentioned description of the operation, the example was given for where the transmission index signal was substituted for one part of an image signal of one line. However for other lines also, the same transmission index signal may be substituted for one part of an image signal. In this case, for simplicity, by having a configuration in the index discriminating device 22 so as to compare the transmission index signals of a plurality of lines, data compensation of the transmission index signal can be performed, and hence the transmission index signal can be more reliably discriminated.

Furthermore, in the case where the pixels which constitute the transmission index signal are made up from a signal of RGB, the light and shade can be changed for each RGB. More specifically, for example two colors are selected from RGB, and for one color the light and shade of a pixel corresponding to a flag is set, while for the other colors, a light and shade the reverse of the light and shade of the pixel corresponding to the flag (that is the light and shade obtained from the difference to the maximum brightness) is set to construct a differential signal. In the case where such a signal is received, then by taking the difference value of the differential signal, the actual signal amplitude can be treated doubly. Hence the transmission index signal can be more reliably discriminated.

Furthermore, in the case where the pixels constituting the transmission index signal are made up of signals of RGB, for example, by selecting two colors from RGB, and setting to one color a light and shade of the pixel corresponding to a flag, and setting to the other colors a threshold value for binarizing a light and shade of a pixel corresponding to a flag, then even in the case where the amplitude or the brightness of the light and shade of the transmission index signal is changed, the transmission index signal can be discriminated. Moreover, in the above mentioned description of the operation, the example was given for where the index discriminating device 22 binarizes the transmission index signal. However a plurality of threshold values may be set beforehand, to make the transmission index signal a multi value. In this case, a large number of image output apparatuses 12 can be controlled with an even smaller number of pixels.

According to the image signal output apparatus, the image output apparatus can select and output an arbitrary frame from the image signal. Consequently, an arbitrary page can be displayed on the image display apparatus which is connected in accordance with the image output apparatus number. Furthermore, since substitution of the transmission index signal within the image period is not performed, the index is not displayed on the display screen of the image display apparatus. Hence there is no obstruction of the screen. Moreover, since updating of the image signal which is stored in the image storing device is not performed, the contents immediately before continue to be displayed. Furthermore, since the transmission index signal is not contained in the image signal, the frame which contains this transmission index signal is one which is selected for all of the image output apparatuses, and a frame selection signal can also be output from the frame selection device.

Moreover, by previously determining the pattern of a header, detection of the header by the index discriminating device is simplified. Consequently, even if the transmission index signal is arranged at an arbitrary position on the time axis of the image signal, the position of the transmission index signal within the image signal can be easily found, so that the transmission index signal can be reliably extracted. Furthermore, the transmission index signal can be constructed by an arbitrary number of pixels. Moreover, the transmission index signal can be constructed by a plurality of pixels which are continuous either horizontally or vertically. Furthermore, this may be constructed by pixels of a two dimensional array arranged horizontally and vertically. Moreover, by constructing so as to compare the transmission index signals of several lines, data compensation of the transmission index signal can be performed, and hence the transmission index signal can be even more reliably discriminated.

Furthermore, in the case where the pixels constituting the transmission index signal are made up of signals of RGB, the light and shade can be changed for each of the RGB. By using the difference value of the differential signal of the light and shade in this manner, the intrinsic signal amplitude can be treated two-fold, so that the transmission index signal can be even more reliably discriminated. Furthermore, in the case where the pixels which constitute the transmission index signal are made up from a signal of RGB, then by selecting two colors from RGB, and setting to one color a light and shade of the pixel corresponding to a flag, and setting to the other colors a threshold value for binarizing a light and shade of a pixel corresponding to a flag, then even in the case where the amplitude or the brightness of the light and shade of the transmission index signal is changed, the transmission index signal can be discriminated. In this manner, a great number of image output apparatuses can be controlled with an even smaller number of pixels.

Second Embodiment

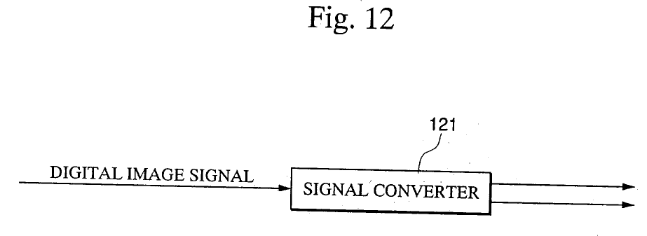

Next is a description of the operation of a second embodiment. In the first embodiment, the description was for the case where the image signal output from the image signal generator 11 was analog. However the image signal output from the image signal generator 11 may be digital. FIG. 12 is a block diagram showing an image signal receiving device 21 according to the second embodiment of the invention. In FIG. 12, a signal converter 121 is a device for converting a digital signal which is transmitted via a signal cable into an image signal Di and a synchronization signal Si.

The digital image signal output from the image signal generator 11 is input to the image signal output apparatus 12 via a connection cable or the like. Subsequently, this digital image signal is converted into an image signal Di and a synchronization signal Si in the signal converter 121 of the image signal receiving device 21 shown in FIG. 12. The image signal Di and the synchronization signal Si output from the signal converter 121 are input to the index discriminating device 22, the frame selection device 24, and the image storage device 25. Other operation is the same as that described for the first embodiment, and hence detailed description of this the operation is omitted.

By configuring in the above manner, as shown in FIG. 1, the image signal output apparatus 12 as shown in FIG. 1 receives the digital image signal which the image signal generator 11 outputs, and can display an arbitrary page on an arbitrary image output apparatus 12. Here, in the above mentioned description of the operation, the transmission index signal was described for a case the same as the first embodiment. However the transmission index signal may also be substituted for an arbitrary bit of one part of the image signal output from the image signal generator.

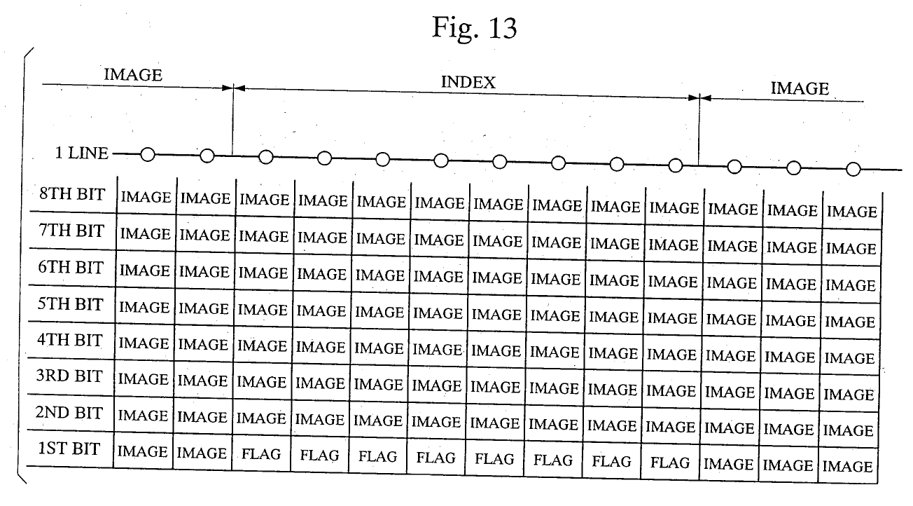

FIG. 13 shows an example where the transmission index signal is substituted for a bit being image data. In more detail, this shows the case where the transmission index signal is substituted for gradation data for a plurality of pixels at a predetermined position, in the case where the image signal is an image signal having for example data of eight bits (that is 256 gradations). That is to say, in FIG. 13, a flag is set for the first bit for which the significance of the gradations is very small. At this time, in the pixel for which the transmission index data is substituted for the least significant bit (that is the first bit), the remaining bits from the eighth bit to the second bit are the original image signal.

The index discriminating device 22 is configured so as to discriminate a least significant bit of a plurality of pixels which are at a predetermined position of the image signal, as the index ID. By configuring in this manner, the index ID can be made hardly recognizable by the user on the display screen (that is highlighting is diminished) and parts with no display due to the presence of the index ID on the display screen, can be essentially eliminated. Here, the description is for the case where the transmission index data is substituted for the least significant bit of the gradation data of a certain pixel. However the configuration is not limited to this, and the transmission index data may be substituted for another gradation bit of the gradation data.

Furthermore, in the case where the image signal of the pixel comprises RGB data, the transmission index signal is substituted for an arbitrary bit in the gradation data of one color (for example R data) within the RGB data. By configuring in this manner, the index ID can be made hardly recognizable by the user on the display screen (that is highlighting is diminished) and parts with no display due to the presence of the index ID on the display screen, can be essentially eliminated. Furthermore, as shown in the first embodiment of the invention, and also in the second embodiment, by adding a parity to the transmission index signal, the transmission index signal can be extracted more reliably.

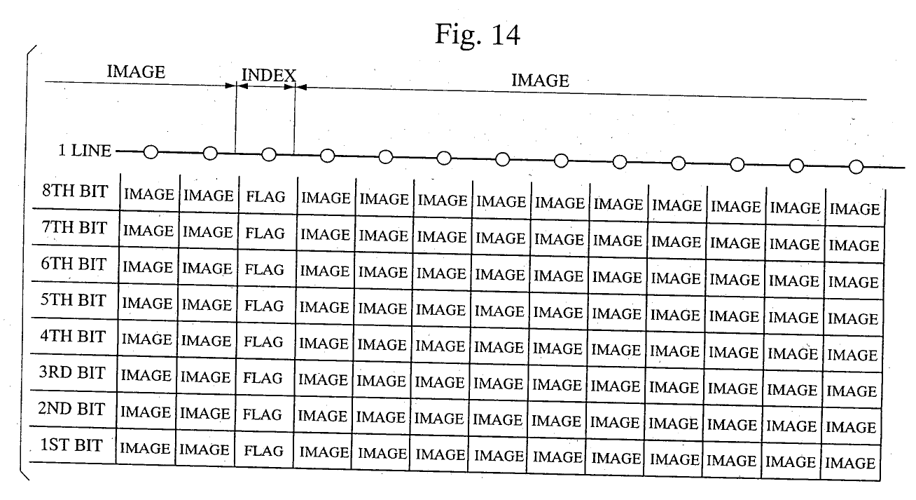

FIG. 14 shows an example of where flags are substituted in the bit depth direction of the image data. In more detail, FIG. 14 shows the case where transmission index data is substituted for gradation data of a single pixel in a predetermined position. In the case where the image signal is an image signal having data of eight bits. At this time, in the case where there is transmission index data above eight bits, this may be substituted using a plurality of pixels. By configuring in this manner, the number of pixels where the transmission index signal is substituted can be kept small, so that the index ID can be made hardly recognizable by the user on the display screen (that is highlighting is diminished), and parts with no display due to the presence of the index ID on the display screen, can be practically eliminated.

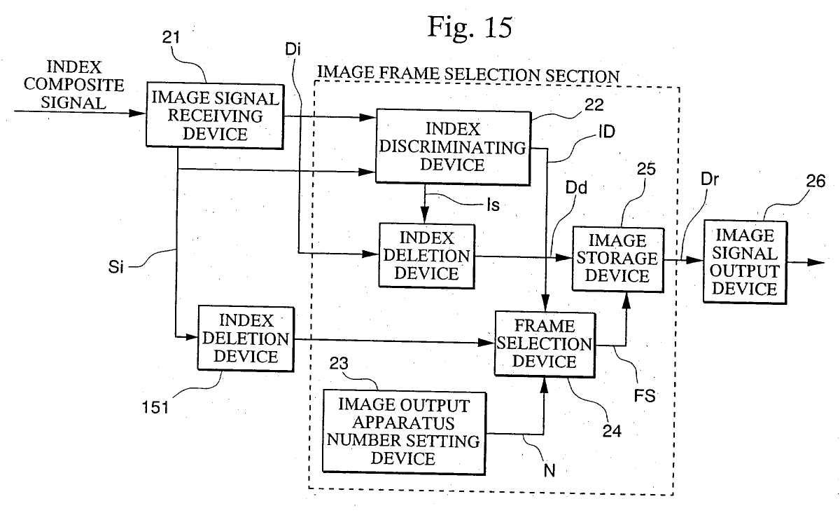

FIG. 15 is a block diagram showing another configuration of the image output apparatus 12 in the second embodiment of the invention. In FIG. 15, numeral 151 denotes an index deletion device for making the index ID on the screen vanish from on the display screen (that is, masking), while Dd denotes an image signal which the index deletion device 151 outputs.

Next is a description of the operation of FIG. 15. The image signal Di output from the image receiving device 21 is input to the index discriminating device 22 and the index deletion device 151. The index deletion device 151 substitutes a “0” for the pixel of the position of the index (that is the timewise position), based on position information Is of the discriminated index of the index discriminating device 22, and thus deletes the transmission index signal. Then, the image signal Dd with the transmission index data deleted is output to the image storage device 25. Other operation is the same as for the first embodiment, and hence description of this operation is omitted. By configuring in this manner, since the index ID is not contained in the image data output from the image signal output device 26, the index ID can be made to vanish from on the display screen in the image display apparatus 13.

Moreover, since the image signal generator comprises a signal converting device, the output image signal may be digital. As a-result, the image signal output apparatus can receive the digital image signal which the image signal generator outputs, and displays an arbitrary page on an arbitrary image output apparatus. Moreover, the index discriminating device is configured so as to discriminate a least significant bit of a plurality of pixels which are at a predetermined position of the image signal, as an index ID. Consequently, the index ID can be made hardly recognizable by the user on the display screen (that is highlighting is diminished) and parts with no display due to the presence of the index ID on the display screen, can be essentially eliminated. Furthermore, the index ID can also be made hardly recognizable on the display screen by providing an index deletion device.

Third Embodiment

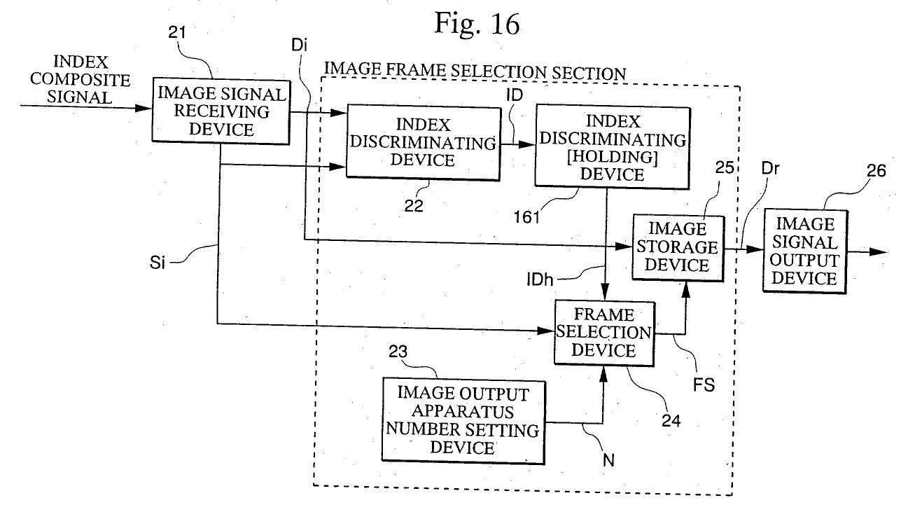

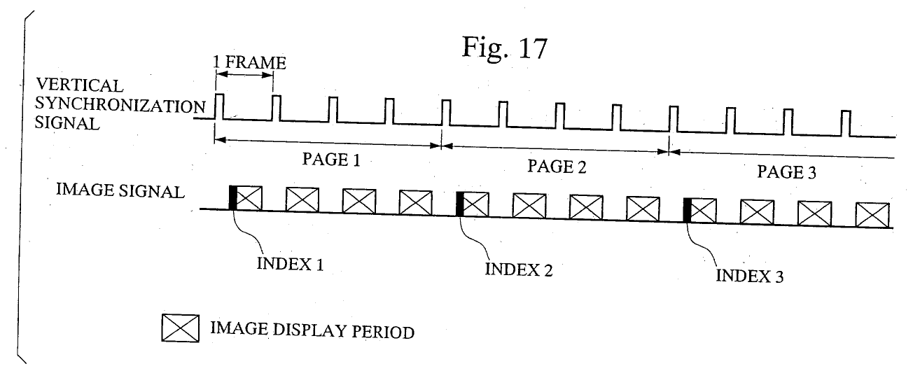

Next is a description of the operation of a third embodiment. FIG. 16 is a block diagram showing the configuration of an image output apparatus 12 in the third embodiment of the invention. In FIG. 16, numeral 161 denotes an index holding device, and IDh denotes an index which is held by the index holding device 161. Furthermore, FIG. 17 is a time chart for explaining the timing of the transmission index signal ID and switching of the page, in the third embodiment of the invention. In FIG. 17, the horizontal axis represents time, and the vertical axis represents voltage. As shown in FIG. 17, the image signal generator 11 substitutes the first transmission index signal for one part of the image signal in the first frame when the page switches.

In the configuration shown in FIG. 16, the index discriminating device 22 discriminates the transmission index signal which has been intermittently substituted for one part of the image signal in a predetermined frame of the image signal by means of the image signal generator 11, and the index ID obtained by the discrimination is output to the index holding device 161. The index holding device 161 holds the input index ID until the next index ID is input, and outputs the held index IDh to the frame selection device 24. Other operation is the same as for the first embodiment and hence description of this operation is omitted.

By configuring in the above manner, then as shown in FIG. 1, the image output apparatus 12 can selectively output pages. Furthermore, since the transmission index signal which the image signal generator 11 has substituted for one part of the image signal is intermittently substituted for one part of the image signal in the image signal, the index ID becomes difficult to see by the user, and parts with no display due to the index ID can be essentially eliminated.

Moreover, in the case where the transmission index signal as shown in FIG. 5 is continuously substituted for one part of the image signal in the respective display periods, then when the index signal is damaged due to reasons such as a mouse being passed over the transmission index signal, the index discriminating device 22 may not be able to normally discriminate the transmission index. At such a time, if the index IDh is held as described above, then even if the index is damaged due to a mouse pointer or the like, since the index holding device 161 is holding the index of the previous frame, then the held index IDh can be used to give a normal output.

Moreover, even if the index signal is obliterated at the time of passing a mouse or the like over the transmission index signal, the index holding device backs up the index ID. Consequently, even if the index is obliterated by a mouse pointer or the like, a normal signal can be output using the index ID being held by the index holding device.

Fourth Embodiment

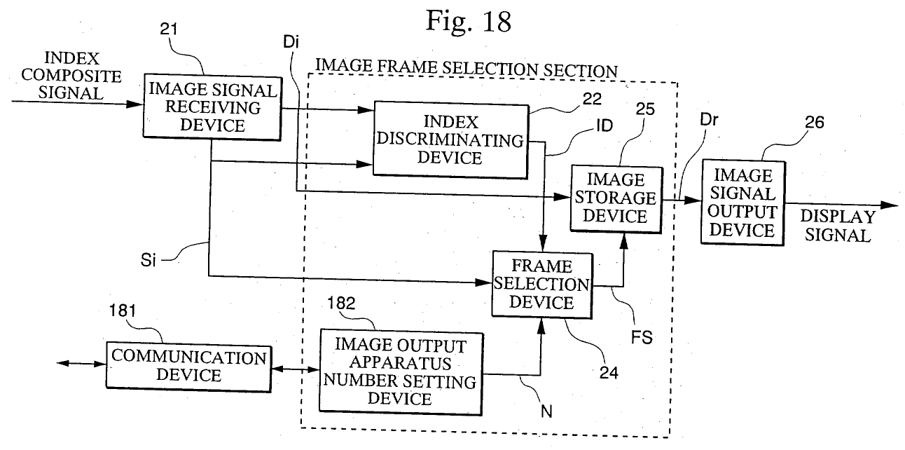

Next is a description of a fourth embodiment. FIG. 18 is a block diagram showing the configuration of an image output apparatus 12 according to the fourth embodiment of the invention. In FIG. 18, numeral 181 denotes a communication device, while 182 denotes an image output signal setting device. In the description of the operation according to the configuration described up until here, the image output apparatus number N of the image output apparatus 12 was set to an arbitrary value by the image output apparatus number setting device 23. In contrast to this, in the fourth embodiment, each one of the image output apparatus numbers N is automatically set by using the communication device 181, to perform reciprocal exchange of information related to the image output apparatus number N, between a plurality of sequentially connected image output apparatuses, or between special image output apparatuses 14 proposed in the disclosure of Japanese Unexamined Patent Application, First Publication No. 2000-352962.

More specifically, the communication devices 181 of a plurality of image output apparatuses 12 or special image output apparatuses 14 are electrically connected by a cable or the like, and sets of respective image output apparatus number setting devices 23 perform communication to set sequential numbers. For example the image output apparatus number N of the image output apparatus 12 connected first to the image signal generator 11, may be made 1, and the image display number N increased one by 1 at a time in the order of sequentially connected connection. Other operation is the same as for the first embodiment and hence description of this operation is omitted.

Furthermore, the communication device 181 may be connected to the image signal generator 11, and the image output apparatus number N set from the image signal generator 11 to the respective image signal output apparatuses 12. Since the image signal generator 11 is a standard PC, there are many cases where this has a much better user interface (that is a keyboard, mouse etc.) than the image signal output apparatus 12 of the invention, or the special image display apparatus 14, and the user can more easily set the image output apparatus number N by the above described configuration. In this manner, by having the communication device 181, the user no longer needs to set the image apparatus number each time, so that convenience is improved for the user.

Furthermore, since the communication device and the index signal generator are connected, the image signal output apparatus number can be set in the respective image signal output devices from the image signal generator. As a result, a user interface which is much better than the conventional image signal output apparatus or a special image display apparatus can be obtained, so that the user can more easily set the image output apparatus number. Furthermore, by providing such a communication device, since the user no longer needs to perform setting of the image apparatus number each time, convenience of the image signal output apparatus is further improved.

Fifth Embodiment

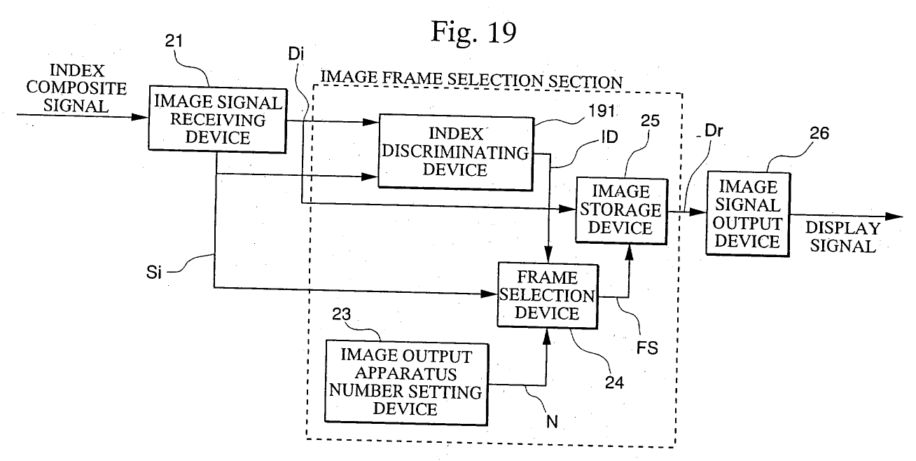

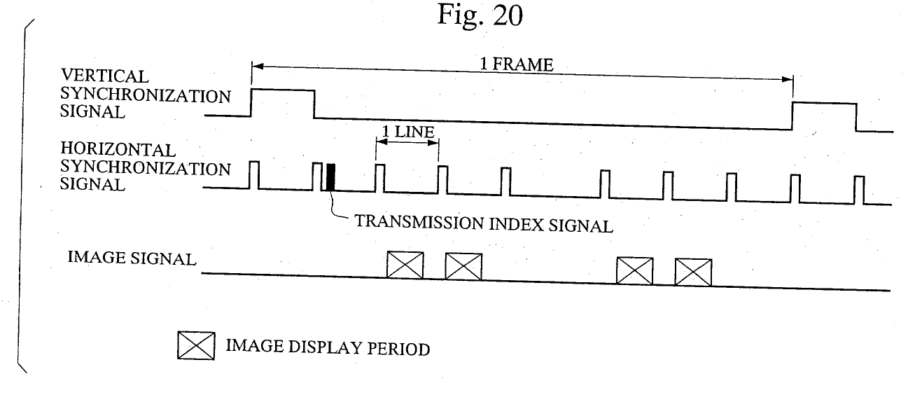

Next is a description of the operation of a fifth embodiment. FIG. 19 is a block diagram showing the configuration of an image output apparatus 12 according to the fifth embodiment of the invention. In FIG. 19, numeral 191 denotes an index judgment device, while 192 denotes an image signal receiving device. Other parts are the same as in FIG. 2 and hence description is omitted. Furthermore, FIG. 20 is a timing chart showing a relationship between image signals and synchronization signals in one frame period, in the fifth embodiment. In FIG. 20 the horizontal axis represents time and the vertical axis represents voltage.

Next is a description of the operation of the image output apparatus 12 shown in FIG. 19. In the description of the first embodiment, the description was given for the case where the image signal generator 11 substitutes the index for one part of the image signal at an arbitrary location of the image signal. However in the fifth embodiment, as shown in FIG. 20, a binarized index is substituted for one part of a synchronous signal at the position of the synchronous signal.

In the image signal receiving device 192 of FIG. 19, an image signal, and a synchronous signal with the transmission index signal substituted for one part of the synchronous signal are input. The image signal receiving device 192 outputs an image signal Di to the image storage device 25, and removes the index from the input synchronization signal, and outputs a synchronization signal Si which does not contain an index, to the frame selection device 24. Furthermore, a synchronization signal SiI which contains the transmission index signal is output to the index judgment device 191. In the index judgment device 191, the index ID is separated and extracted from the input synchronization signal SiI, and output to the frame selection device 24. Other operation is the same as for the first embodiment, and hence description is omitted.

By having the configuration as described above, it is possible to select and output an arbitrary frame from the received image signal without influencing the image. Furthermore, since the synchronization signal is input at a logical level, a stable index signal with high noise immunity can be extracted, and hence there is little likelihood of the occurrence of a malfunction.

In the description of the configuration of the above mentioned series of embodiments, and the operation thereof, the description was given for the case where the transmission index signal was substituted for one part of the synchronization signal at a predetermined position (for example a position on the timewise axis) of the horizontal synchronization signal. However this may be substituted at a predetermined position from the vertical synchronization signal.

Moreover, by providing an image signal receiving device and an index discriminating device, arbitrary frames can be selected and output from the received image signal, without having an influence on the image. Furthermore, since the synchronization signal is input by a digital signal, a stable index with high noise immunity can be extracted, so that there is little likelihood of a malfunction occurring.

Sixth Embodiment

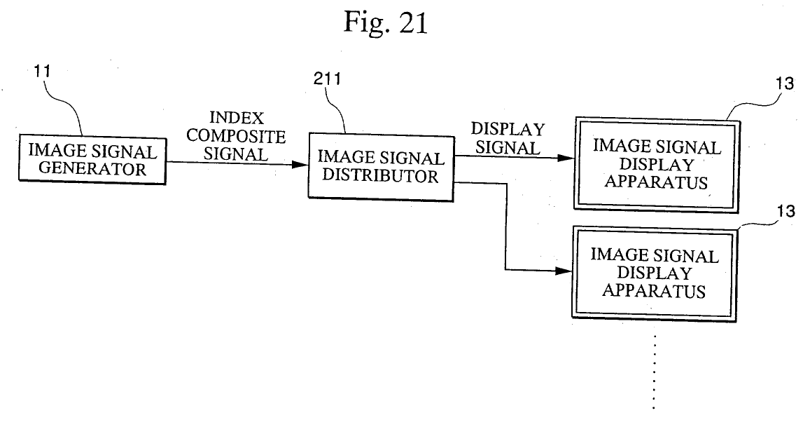

Next is a description of the operation of a sixth embodiment. FIG. 21 is a block diagram showing the configuration of an image display system according to the sixth embodiment of the invention. In FIG. 21, numeral 11 denotes an image signal generator described for the first embodiment, numeral 211 denotes an image signal distributor, and numeral 13 denotes an image display apparatus. In the sixth embodiment, as shown in FIG. 21, the image signal distributor 211 sets the image output apparatus number, and is connected to the image signal generator 11 by a connection cable or the like. Furthermore, the image signal distributor 211 and a plurality of image display apparatuses 13 are also similarly connected by a connection cable or the like.

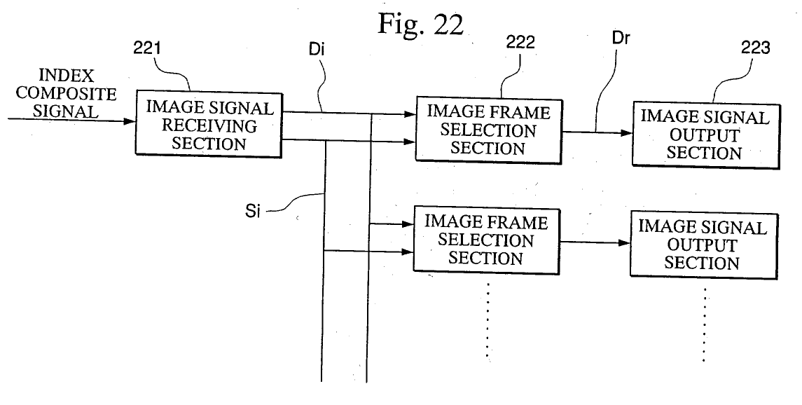

Moreover, FIG. 22 is a block diagram showing the configuration of the image signal distributor 211. In FIG. 22, numeral 221 denotes an image signal receiving section, 222 denotes an image frame selection section, and 223 denotes an image signal output section. The function and configuration of these has been described for the above mentioned first, second and third embodiments, and hence duplicate description is omitted.

The plurality of image frame selection sections 222 each have an image output apparatus number setting device 23, and set individual image output apparatus numbers N. However, since this number is independently set, then there is also the case where the same image output apparatus number N is set for sets of image frame selection devices 222 which are connected in parallel. In the case where the same image output apparatus numbers N are set, then the same signal is output from the image signal output sections 223 which are connected to these image output apparatuses.

Moreover, these may have a communication device such as described for the above mentioned fourth embodiment. In this case, a single communication device may be provided for the plurality of image frame selection sections 222, so that image output apparatus numbers N can be set to the respective image frame selection devices 222. Furthermore, the configuration as described for the above mentioned fifth embodiment is also possible. In this case, the synchronization signal SiI which contains the index signal is the plurality of image frame selection devices 222 which are connected in parallel, and processed within these image frame selection devices 222.

In the configuration as described for the first through fifth embodiments, an image signal output apparatus 12 was necessary for each one of the image signal display apparatuses 13. However by having the configuration of the above mentioned sixth embodiment, a signal can be delivered by the plurality of image signal display apparatuses 13 by one image signal distributor. Furthermore, the frame of the received image signal can also be selected and displayed.

Moreover, the signal can be delivered to a plurality of image signal display apparatuses by one image signal distributor. Consequently, there is no longer the requirement for an image signal output apparatus for each of the image signal display apparatuses, and hence the overall system can be simplified and a cost reduction achieved. Furthermore, the frame of the received image signal can also be selected and displayed.

1. An image signal output apparatus comprising:
an image signal receiving device which receives a composite signal containing, an image signal comprising a plurality of image frames, a synchronization signal corresponding to said image signal, and a transmission index signal substituted for one part of said image signal in an arbitrary image frame of said image signal, and outputs said image signal and said synchronization signal;
an index discriminating device which discriminates a transmission index signal contained in either of an image display period and an image non-display period in an image frame, based on the image signal and the synchronization signal output from said image signal receiving section;
an image output apparatus number setting device for outputting an image output apparatus number set for its own apparatus;
a frame selection device which, based on an index signal output by said index discriminating device, and an image output apparatus number of its own apparatus output by said image output apparatus number setting device, outputs a frame selection signal for selecting said image frame contained in an image signal;
an image storage device which stores an image signal corresponding to an image frame in accordance with a frame selection signal output from said frame selection device; and
an image signal output device which outputs an image signal corresponding to an image frame.

2. An image signal output apparatus according to claim 1, wherein an image frame selection section comprises; said index discriminating device, said image output apparatus number setting device, said frame selection device, and said image storage device.

3. An image signal output apparatus according to either one of claim 1 and claim 2, further comprising an index holding device which holds an index signal

4. An image signal output apparatus according to either one of claim 1 and claim 2, further comprising a communication device connected to said image output apparatus number setting device.

5. An image signal output apparatus according to either one of claim 1 and claim 2, wherein said image signal output device comprises a signal converting device which converts to a necessary format for display on an existing display apparatus.

6. An image signal output apparatus according to either one of claim 1 and claim 2, wherein said image signal output device comprises a D/A converter which converts a digital signal to an analog signal.

7. An image signal distributor comprising said image signal receiving device, an image frame selection section, and an image signal output section which outputs an image signal corresponding to an image frame, and
said image frame selection section comprises:
an index discriminating device which, based on an image signal and a synchronization signal output from an image signal receiving device, discriminates a transmission index signal which is contained in either of an image display period or an image non display period in an image frame;
an image output apparatus number setting device for outputting an image output apparatus number which is set for its own apparatus;
a frame selection device which, based on an index signal output by said index discriminating device and an image output apparatus number of its own apparatus output by said image output apparatus number setting device, outputs a frame selection signal for selecting said image frame contained in an image signal; and
an image storage device which stores an image signal corresponding to an image frame in accordance with a frame selection signal output from said frame selection device, and
said image frame selection section and said image signal output section are made up of several sections.

8. A control method for an image signal which performs control of an image signal from receiving an index composite signal up until outputting a display signal comprising;
a first step for receiving an index composite signal containing a transmission index signal which is substituted for one part of an image signal in an arbitrary image frame of an image signal comprising a plurality of image frames; and
a second step for selecting an image frame to be output by its own apparatus, from a plurality of image frames based on a transmission index signal contained in the received index composite signal, and outputting an image signal corresponding to the selected image frame.

9. A control method for an image signal according to claim 8, wherein said second step further comprises;
a procedure for discriminating a transmission index signal from an index composite signal and outputting an index signal;
a procedure for outputting a frame selection signal based on an output index signal and an image output apparatus number set for its own apparatus;
a procedure for selecting an image frame contained in an image signal in accordance with the output frame selection signal;
a procedure for storing an image signal corresponding to the selected image frame; and
a procedure for outputting the stored image frame.
